(19) United States
(12) Patent Application Publication
(10) Pub. No.: US 2014/0162221 A1
(43) Pub. Date: Jun. 12, 2014

(54) Nutrition-Balancing Containers and Method of Use

(71) Applicants: Myo Nwe, Charlotte, NC (US); Sandeep Grewal, Rock Hill, SC (US)

(72) Inventors: Myo Nwe, Charlotte, NC (US); Sandeep Grewal, Rock Hill, SC (US)

(21) Appl. No.: 13/932,752

(22) Filed: Jul. 1, 2013

Related U.S. Application Data
(60) Provisional application No. 61/667,080, filed on Jul. 2, 2012.

(51) Int. Cl. A23L 1/29

(52) U.S. Cl. CPC A23L 1/293
USPC 434/127

(57) ABSTRACT

A four step system for weight loss in a person who is overweight or obese by introducing protein, vegetable, and starch (carbohydrate) in specific ratios to promote fat utilization and weight loss from fat composition of the person's entire body. The system utilizes portion control meal plates for weight loss in an overweight or obese person that have different protein, vegetable, and starch (carbohydrate) intake portions.

### RELATED APPLICATIONS

This application claims priority to U.S. Provisional Application No. 61/667,080 filed Jul. 2, 2012. The entire contents of the above application are hereby incorporated by reference as though fully set forth herein.

### FIELD

This invention relates broadly and generally to a nutrition-balancing container system and method for foods and beverages and a method for weight loss.

### BACKGROUND

The percentage of overweight people has increased year after year making obesity a disease reaching epidemic proportions in some areas around the world. There are many health risks associated with being overweight and it is known that obesity can contribute to the morbidity and mortality of individuals that suffer from diseases such as hypertension, stroke, diabetes mellitus type II, gallbladder disease and heart disease. A common strategy used in weight loss efforts is to reduce the amount of food a person consumes in an effort to reduce caloric consumption. Sometimes the diet involves restriction of certain macronutrient groups, such as fats or carbohydrates, in an effort to reduce caloric intake. However, studies have shown that restricting and excluding a specific macro-nutrient group in this manner is not feasible in the long term as subjects are unable to maintain such rigorous restriction standards and end up gaining the weight lost as a “rebound” effect and may end up with further unhealthy fat accumulation. Further, a restricted diet has been shown to negatively affect the mood levels of the subjects, which does not help weight loss in the long term.

Clinical studies well known in the prior art have suggested that the size of the plates used by subjects can control the amount of food a person consumes. Other studies well known in the prior art have demonstrated that high carbohydrate content in a meal can increase the unwanted fat accumulation in one's body. Further, it is commonly believed that high caloric dense food, such as high fat content meals, may also contribute to obesity. Finally, a high fat diet is known to cause food addiction, neurotoxicity, neurodegradation and hence obesity

It is well known that common complaints to traditional “diets” is that individuals must change their current food choices and cooking style, buy new and expensive diet products, and/or use difficult or time consuming methods to calculate and track food consumption. Another complaint is the difficulty individuals have after the active weight loss phase to maintain their weight loss. Thus, there is a need for a method and method where individuals are not required to: (a) adapt their food content; (b) calculate or track food consumption; (c) change their cooking style; and (d) buy new products. The method and method should be easy to use and safe to use by everyone, including those with heart disease, lung disease, metabolic diseases such as diabetes mellitus type 2 and pregnancy. The system and method would address both active weight loss and maintenance of weight lost.

### BRIEF SUMMARY OF THE INVENTION

In exemplary embodiments, the present nutrition-balancing containers, method of use and system for weight loss are built on a base theory of portion control of an entire meal, at different times of the day, and the portion of the content of the nutrients of a meal, which helps to promote loss of fat and body weight. The system and method uses portion control plates that are scientifically designed with four steps for different nutrient portions for each step.

In the preferred embodiment of the present invention, four meal plates are used in four steps. Step one creates a fat burning mode by significantly reducing the starch (carbohydrate) intake and increasing protein intake. The body has a reserve of glycogen storage, largely in the liver and muscle, for energy in the first 48 hours to 2 weeks from the point of calorie limitation. By limiting excess carbohydrate intake in the body, the fat synthesis is slowed. By promoting the protein intake, the muscle breakdown for continuous supply for the glycogen storage is slowed, thereby eliminating the need to break down muscle for energy. Step one was designed to serve the purpose of creating a higher thermogenic effect and satiety. Subsequent steps are designed to introduce starch (carbohydrate) neuro protective effect by creating less oxidative stress to the body and enhance metabolism, yet the steps still contain a higher protein portion to continue the thermogenic energy expenditure. Step two restarts a controlled portion of starch (carbohydrate) in a meal for steady fat burning mode. Step three prepares the individual for stable weight/fat loss with proper nutrients portioning. Step four is for maintenance and helps the individual develop a habit of well-balanced meal consumption for life.

The plates do not limit the style of cooking by an individual and there is no cost associated with the system and method after buying the plates. The individual will use the plates when they are preparing for a meal. Meat is placed in the red section, vegetables are placed in the green section and starch is placed in the blue section.

This step portion plate system differs from other diet plans in that all the steps have the same total portion size but the change is in the macronutrients ratio. The sandwich cutter, the breakfast plate portions and the cutters are volume limited for every single time—it does not get bigger or smaller at any point. The same total portion at every single mean makes the stomach adapt to the same volume portion. The same total portion across the entire daily meals has been shown to be a key factor to losing weight, as it may change the microbacterial and hormonal systems to help lose weight. Another benefit of consistent portioning is that it makes it easier to keep the habit for a longer time than the random nature eating habit, which helps explain the long-term success of weight loss when using this portion method.

### BRIEF DESCRIPTION OF THE DRAWINGS

FIG. 1 shows the breakfast platter.

FIG. 2 shows step 1 plate.

FIG. 3 shows step 2 plate.

FIG. 4 shows step 3 plate.

FIG. 5 shows step 4 plate.

FIG. 6 shows various food cutters.

### DETAILED DESCRIPTION

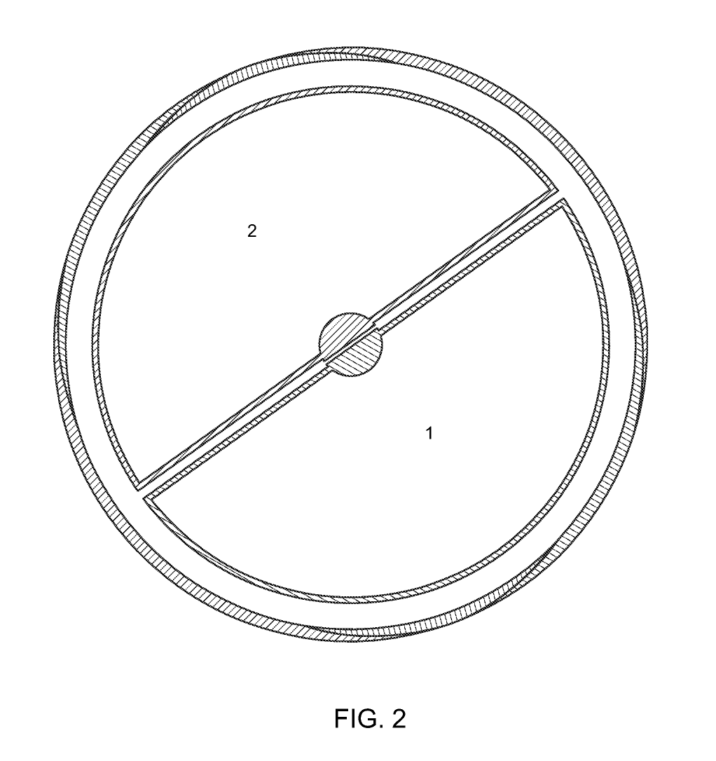

The method is comprised of a set of plates, dishes, cups, etc. that is used in an attempt to lose weight and maintain weight using a portion control over four stages. The lunch and dinner plates are represented in FIGS. 2-5. The plates for men have about a 9-inch eating area and the plates for women have about an 8-inch eating area. The depth of the lunch and dinner plates for both men and women is approximately 1.2 cm.

Step 1 lunch and dinner plate is shown in FIG. 2 and is designed to have about 50% area coverage of the plate for the protein intake portion 1 and about 50% area coverage of the plate for the vegetable intake portion 2. In a preferred embodiment, protein intake portion 1 is outlined in red shading and vegetable intake portion 2 is outlined in green shading.

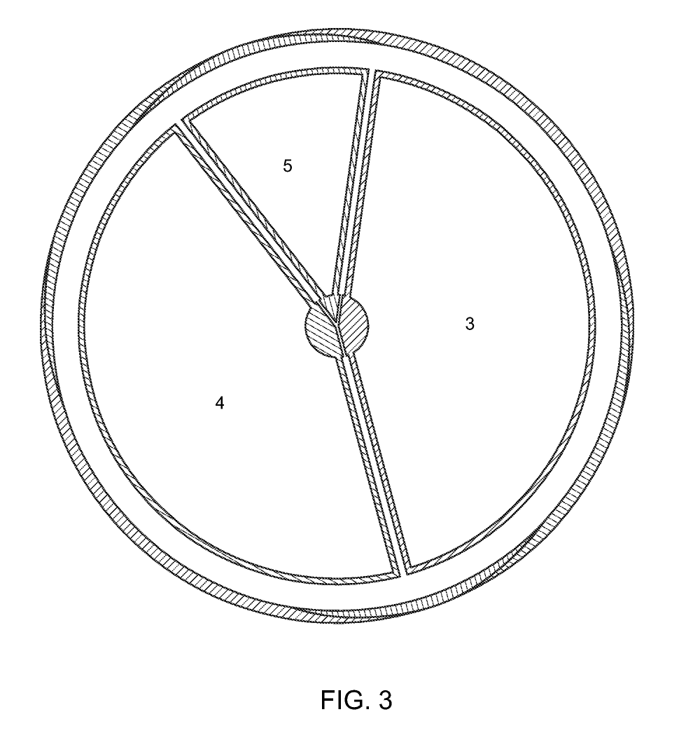

Step 2 lunch and dinner plate is shown in FIG. 3 and is designed to have about 44% area coverage of the plate for the protein intake portion 3, about 44% area coverage of the plate for the vegetable intake portion 4, and about 12% area coverage of the plate for the starch (carbohydrate) intake portion 5. In the preferred embodiment, protein intake portion 3 is outlined in red shading, vegetable intake portion 4 is outlined in green shading and starch (carbohydrate) intake portion 5 is outlined in blue shading.

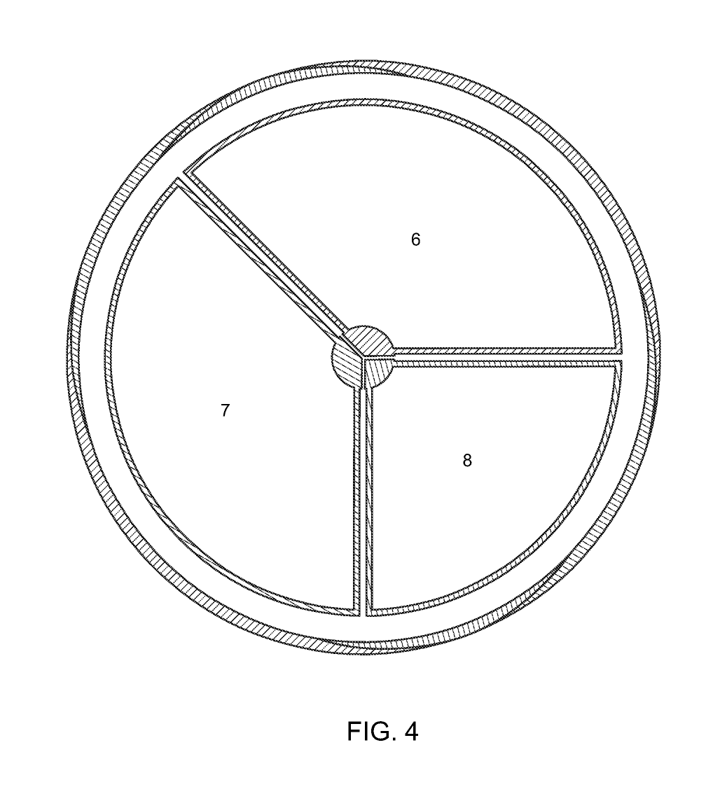

Step 3 lunch and dinner plate is shown in FIG. 4 and is designed to have about 37.5% area coverage for protein intake portion 6, about 37.5% area coverage for vegetable intake portion 7 and about 25% area coverage for starch (carbohydrate) intake portion 8. In the preferred embodiment, protein intake portion 6 is outlined in red shading, vegetable intake portion 7 is outlined in green shading and starch (carbohydrate) intake portion 8 is outlined in blue shading.

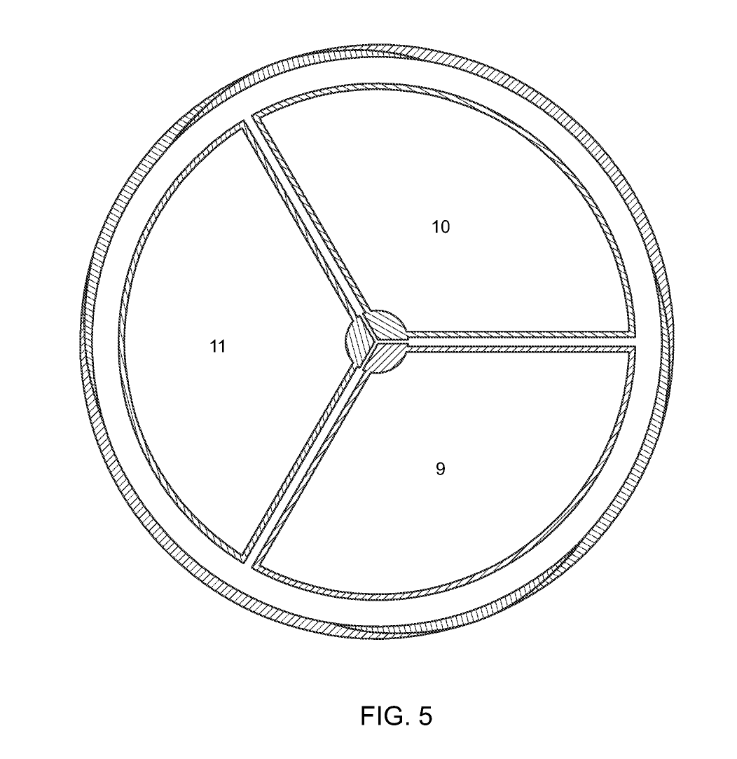

Step 4 lunch and dinner plate is shown in FIG. 5 and is designed to have about 33.3% area coverage for protein intake portion 9, about 33.3% area coverage for vegetable intake portion 10, and about 33.3% area coverage for starch (carbohydrate) intake portion 11. In the preferred embodiment, protein intake portion 9 is outlined in red shading, vegetable intake portion 10 is outlined in green shading and starch (carbohydrate) intake portion 11 is outlined in blue shading.

Fat is highly calorie dense, so in order to achieve the desired level of fat of about 20-30% of the entire meal, the fat was not included in the sections of the plates. The desired amount of fat will mainly come from meat/cheese without addition of an extra fat section.

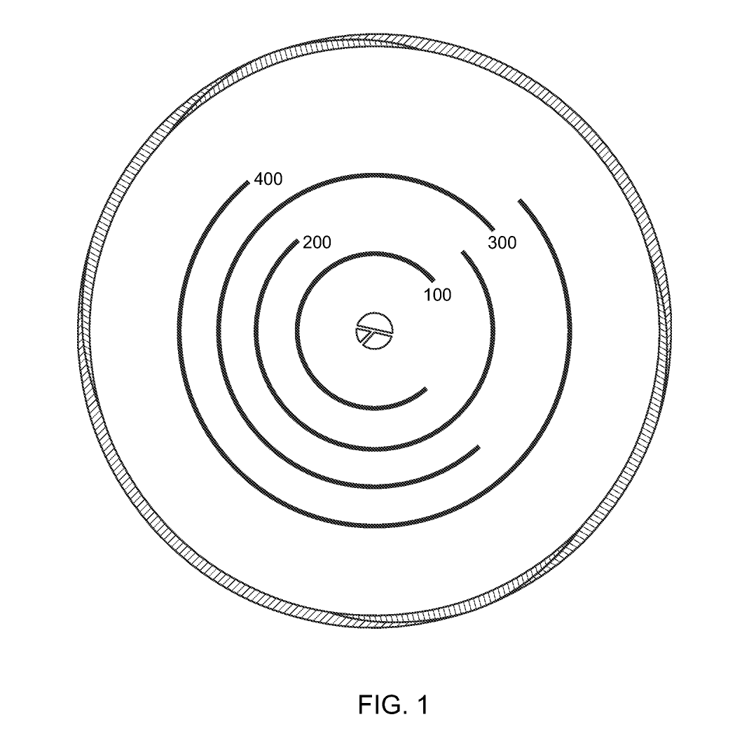

FIG. 1 shows the breakfast platter used to portion common breakfast items such as a bagel, muffin, waffle and pancake. The plate is used by both men and women and is marked in increments. The partial circle shown starting at 100 indicates about a 2-inch diameter breakfast food, for example a muffin. The partial circle shown starting at 200 indicates about a 3-inch diameter breakfast food, for example a bagel. The partial circle shown starting at 300 indicates a 4-inch diameter breakfast food, for example a waffle. The partial circle shown starting at 400 indicates a 5-inch diameter breakfast food, for example a pancake. The purpose of the portion-controlled plates is to achieve reduced caloric intake and thereby creating a negative calorie balance to promote weight loss. The portion control plates are also used to group foods with similar calorie density. For example, a muffin and cookies are in similar nature in calories in relation to size as are (1) bagels and English muffins; (2) bread and waffles; (3) cereal and oatmeal and (4) snack of potato chips and tortilla chips.

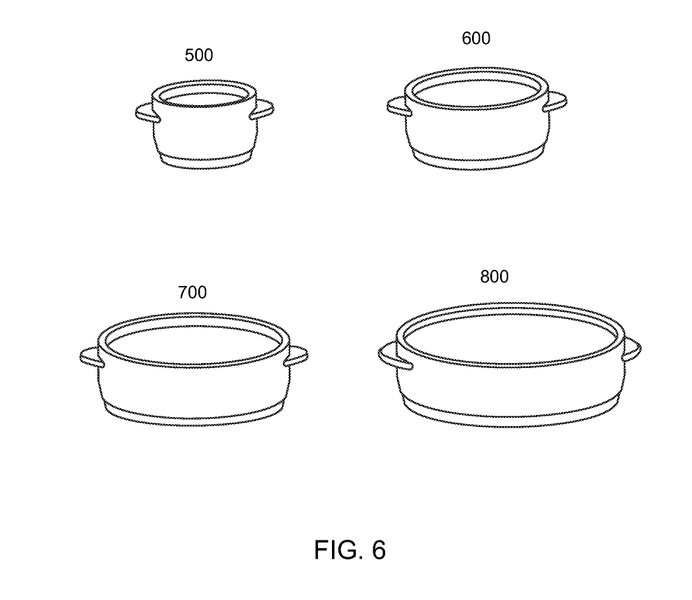

FIG. 6 shows a set of circular cutters with various diameters used for cutting breakfast foods for both men and women to appropriate portion sizes. In the preferred embodiment, cutter 500 has about a 2-inch diameter and is used for muffins, cutter 600 has about a 3-inch diameter and is used for bagels, cutter 700 has about a 4-inch diameter and is used for sandwiches and waffles and cutter 800 has about a 5-inch diameter and is used for pancakes.

The method may also include a breakfast/cereal bowl wherein the cereal or other breakfast food intake capacity is about 16 ounces for both men and women. The breakfast/cereal bowl is about 5.5 inches in diameter and about 2 inches in depth. The method may also include a coffee mug or hot drink mug wherein the liquid intake capacity is about 8 ounces. Many drinks contain simple carbohydrates that create binging and addiction, thus the cold drink cup and the hot drink cup portion are specifically designed to avoid both binging and addiction.

The method may further include a soup bowl used by both men and women that is about 5.5 inches in diameter and about 2 inches in depth. The method may also include a cold drink/juice glass for men and women wherein the liquid intake capacity is about 8 ounces. The method may further include a fruit saucer for men and women wherein the fruit intake capacity is about 8 ounces. The fruit saucer is about 5.5 inches in diameter and about 1 inch deep. The method may also include a set of specially reduced sized spoon and fork to slow food intake and reduce gorging.

Two exemplary protocols for using the plates for the weight loss method described herein are shown below:
(a) For Strong Willed People:

First month: Step 1 plate

Second month: Step 2 plate

Third month: Step 3 plate

Maintenance: Step Maintenance plate
(b) For Weak Willed People:

First month: Step 3 plate

Second month: Step 2 plate

Third month: Step 1 plate

Fourth month: Step 2 plate

Fifth month: Step 3 plate

Maintenance: Step Maintenance plate

Another embodiment of the present invention is a four step system for weight loss in a person who is overweight or obese by introducing protein, vegetable, and starch (carbohydrate) in specific ratios to promote fat utilization and weight loss from fat composition of the person's entire body, the system comprising: (a) creating a fat burning mode in the person's body by increasing their protein intake and reducing their starch (carbohydrate) intake; (b) resuming the amount of starch (carbohydrate) intake for steady fat burning; (c) preparing for the stable weight and fat loss with proper nutrient portions; and (d) developing a habit of a well balanced meal consumption for life.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for weight loss in an overweight or obese person, the method comprising using four lunch and dinner meal plates having different protein, vegetable, and starch (carbohydrate) intake portions over four steps, wherein:
step 1 comprises using a first lunch and dinner meal plate having about 50% area coverage of the said first plate for protein intake portion and about 50% area coverage of said first plate for vegetable intake portion;
step 2 comprises using a second lunch and dinner meal plate having about 44% area coverage of said second plate for protein intake portion, about 44% area coverage of said second plate for vegetable intake portion, and about 12% area coverage of said second plate for starch (carbohydrate) intake portion;
step 3 comprises using a third lunch and dinner meal plate having about 37.5% area coverage of said third plate for protein intake portion, about 37.5% area coverage of said third plate for vegetable intake portion, and about 25% area coverage of said third plate for starch (carbohydrate) intake portion; and
step 4 comprises using a fourth lunch and dinner meal plate having about 33.3% area coverage of said fourth plate for protein intake portion, about 33.3% area coverage of said fourth plate for vegetable intake portion, and about 33.3% area coverage of said fourth plate for starch (carbohydrate) intake portion,
wherein the four steps result in weight loss in the overweight or obese person.

2. The method of claim 1, further comprising using a breakfast meal plate and breakfast cutter, wherein the breakfast meal plate includes base markings for intake portions of common breakfast items and the breakfast cutter cuts food into intake portions including about a 2 inch diameter marking and cutting a muffin; about a 3 inch diameter marking and cutting a bagel; about a 4 inch diameter marking and cutting a waffle; and about a 5 inch diameter marking and cutting a pancake.

3. The method of claim 1, further comprising using a breakfast cereal bowl, wherein the breakfast cereal bowl intake portion is about 16 ounces in capacity.

4. The method of claim 1, further comprising using a soup bowl or a fruit saucer, wherein the soup bowl and fruit saucer intake portions are about 8 ounces in capacity.

5. The method of claim 1, further comprising using a coffee cup, mug or hot beverage container; or a cold beverage container, wherein the coffee cup, mug or hot beverage container and cold beverage container intake portions are about 8 ounces in capacity.

6. The method of claim 1, further comprising using spoons and forks with varying capacities for holding the protein, vegetable, and starch (carbohydrate) portions for added control over intake portions.

7. The method of claim 1, wherein the lunch and dinner meal plates are color-coded or marked for intake portions.

8. The method of claim 1, wherein a female person uses about an 8 inch diameter eating area lunch and dinner meal plate; and a male person uses about a 9 inch diameter eating area lunch and dinner meal plate.

9. The method of claim 1, wherein each of the four meal plates provides less caloric intake portions and results in the person's weight loss.

10. The method of claim 1, wherein each of the four steps lasts for about a month, or each of the four steps lasts until the person reaches a desired weight loss.

11. The method of claim 1, wherein the four steps are used to maintain the person's desired weight after weight loss.

12. Meal plates for weight loss in an overweight or obese person, the meal plates comprising four lunch and dinner meal plates having different protein, vegetable, and starch (carbohydrate) intake portions, wherein:
a) a first lunch and dinner meal plate has about a 50/50% area coverage of the plate for protein and starch (carbohydrate) intake portion;
b) a second lunch and dinner meal plate has about a 44/44/12% area coverage of the plate for protein, vegetable, and starch (carbohydrate) intake portion, respectively;
c) a third lunch and dinner meal plate has about a 37.5/37.5/25% area coverage of the plate for protein, vegetable, and starch (carbohydrate) intake portion, respectively; and
d) a fourth lunch and dinner meal plate has about a 33.3/33.3/33.3% area coverage of the plate for protein, vegetable, and starch (carbohydrate) intake portion.

13. The meal plates of claim 12, further comprising a breakfast meal plate, wherein the breakfast meal plate includes base markings for intake portions of common breakfast items including about a 2 inch diameter marking for a muffin; about a 3 inch diameter marking for a bagel; about a 4 inch diameter marking for a waffle; and about a 5 inch diameter marking for a pancake.

14. The meal plates of claim 12, further comprising a breakfast cereal bowl, wherein the breakfast cereal bowl intake portion is about 16 ounces in capacity.

15. The meal plates of claim 12, further comprising a soup bowl or a fruit saucer, wherein the soup bowl and fruit saucer intake portions are about 8 ounces in capacity.

16. The meal plates of claim 12, further comprising a coffee cup, mug or hot beverage container; or a cold beverage container, wherein the coffee cup, mug or hot beverage container and cold beverage container intake portions are about 8 ounces in capacity.

17. The meal plates of claim 12, wherein the lunch and dinner meal plates are color coded or marked for intake portions.

18. The meal plates of claim 12, wherein a female person uses about an 8 inch diameter eating area lunch and dinner meal plate; and a male person uses about a 9 inch diameter eating area lunch and dinner meal plate.

19. The meal plates of claim 12, wherein each of the four meal plates provide less caloric intake portions and results in the person's weight loss.

20. A four step system for weight loss in a person who is overweight or obese by introducing protein, vegetable, and starch (carbohydrate) in specific ratios to promote fat utilization and weight loss from fat composition of the person's entire body, the system comprising:
